(19) United States
(12) Patent Application Publication
(10) Pub. No.: US 2016/0180344 A1
(43) Pub. Date: Jun. 23, 2016

(54) COMMUNICATION DEVICE INTERFACES FOR TRANSACTION APPROVAL AT A MERCHANT LOCATION

(71) Applicant: EBAY INC., San Jose, CA (US)

(72) Inventors: Todd Studnicka, Omaha, NE (US); Kyle Arthur Loftis, Papillion, NE (US); Katie Moran, Lutherville, MD (US); May Zabaneh, Austin, TX (US)

(21) Appl. No.: 14/578,273

(22) Filed: Dec. 19, 2014

(51) Int. Cl. G06Q 20/42

(52) U.S. Cl. CPC G06Q 20/425

(57) ABSTRACT

There are provided systems and methods for a communication device interfaces for transaction approval at a merchant location. A user may generate a transaction at a merchant location, for example, by selecting items for purchase and scanning the items for purchase into the transaction. A merchant device may generate the transaction or the user may generate the transaction on a communication device by selecting items from a merchant application or scanning the items in through an input device. Once generated, the transaction may be communicated to a payer device for approval of the transaction and payment by a payer associated with the payer device. The payer may pay for the transaction, select only certain items in the transaction, or reject the transaction. The user may be notified of the payer's decision on their communication device. The payer may also request additional information from the merchant.

### TECHNICAL FIELD

The present application generally relates to communication device interfaces for transaction approval at a merchant location and more specifically to communicating a transaction and/or item information for items in the transaction to a payer party for approval and payment.

### BACKGROUND

A user, such as a consumer, may wish to purchase items but not have available cash or funds in a checking or credit account. For example, young children and teenagers may have limited budgets provided to them by their parents or guardians. In such cases, the consumer may not be able to complete a purchase and may require their guardian to return to the merchant location to purchase the item. In other cases, a merchant, such as a restaurant or movie theater, may lose a purchase as the consumer may not wish to return to the merchant location and engage in the transaction at some future time. Thus, merchants, consumers, and payers for transactions may all be inconvenienced when the consumer does not have available funds to complete a transaction. While payers may provide the consumer party (e.g., their child, ward, or other party they provide fund to) with cash or a payment card, the payer may feel uncomfortable that the consumer may utilize such funds for unauthorized purchases. Some payment cards may provide limited usage with specific merchants as well as based on account purchase histories. Cash does not provide such options and such payment cards still may be utilized to purchase unauthorized items at authorized locations (e.g., alcohol sales at restaurants, purchases of unauthorized clothing or school materials, etc.).

### BRIEF DESCRIPTION OF THE DRAWINGS

FIG. 1 is a block diagram of a networked system suitable for implementing the processes described herein, according to an embodiment;

FIG. 2 is an exemplary system environment showing a communication device generating a transaction with a merchant device for approval from a payer, according to an embodiment;

FIG. 3 is an exemplary system environment showing a payer device receiving an approval and/or rejection for payment of transaction and communicating the approval and/or rejection to the user's communication device, according to an embodiment;

FIG. 4 is a flowchart of an exemplary process for communication device interfaces for transaction approval at a merchant location, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide for communication device interfaces for transaction approval at a merchant location. Systems suitable for practicing methods of the present disclosure are also provided.

A first user, such as a child, ward, or delegate, of another paying party acting as a consumer party, may create a transaction with a merchant by visiting a merchant location and selecting items for purchase. Items may include products, services, and/or other purchasable material referred to collectively as “item” or “items” herein. The first user may visit the merchant location where the merchant or first user selects the items for purchase and adds them to a transaction through at least one of a communication device in possession of the first user and a merchant device at the merchant location. For example, the user may capture an image of an item or an item code (e.g., alphanumeric, bar, and/or QR code) to add to the transaction using the communication device or may access a merchant device/merchant website to select items to add to the transaction. In other embodiments, the user may carry one or more items to a merchant device, such as a point of sale device, which may determine or update the transaction as necessary. When generating the transaction, item information for the selected items may be accessed, for example, from a merchant database, which may include a price for the item(s). The transaction may be generated for the one or more items using the item information for each of the item(s). Once the transaction is generated, the first user may wish to checkout and pay for the transaction with the merchant.

When completing a payment for the transaction and/or one or more item(s) in the transaction, the first user may request payment for the transaction from a second user, such as a parent, guardian, or other user acting as a payer party for at least one item in the transaction. The first user may request to have the transaction communicated to a device of the second user. In various embodiments, the first user may add a message for the second user that is included with the transaction. For example, the first user may let the second user know why payment is requested from the second user. The communication device may transmit the transaction (and message where applicable) directly to a device of the second user. However, in other embodiments, the first user may have a payment provider service transmit the transaction (and message where applicable) to the device of the second user, or may request that the merchant device for the merchant transmit the transaction (and message where applicable) to the device of the second user. Thus, the first user may provide the payment provider service and/or merchant with contact information for the second user, such as a name, an email address, a phone number, an account identifier, and/or a messaging identifier for the second party.

When communicating the transaction to the device of the second user, the second user may be provided with at least the transaction balance, and may also be provided with item information for each item in the transaction and individual item price for each item in the transaction. In other embodiments, only information for item(s) in the transaction that the first user is requesting the second user to pay for is communicated to the second user. The second user may also be provided with contact information for the merchant or may be provided with an option to contact the merchant in order to request or view merchant/item/transaction information, ask questions from a representative of the merchant (e.g., questions about items, the transaction, and/or the merchant) and provide direct payment to the merchant. Such options may be completed using a merchant application and/or merchant website.

After receiving the transaction, the second user may view the transaction (and message where applicable) on a payment module of the second user device and make decisions about payment for the transaction and/or one or more items in the transaction. The second user may choose to pay for the entire transaction or decline the transaction, for example, by selecting an “Yes”/“Accept”/“Approve” option in the payment module or a “No”/“Reject”/“Decline” in the payment module. The second user may also choose to pay for only part of the transaction. When choosing to pay for only part of the transaction, the second user may choose to pay for a percentage of the transaction and/or a fixed amount for the transaction (e.g., $50). Additionally, the second user may choose to only pay for certain items in the transaction (e.g., a school textbook in the transaction but not novelty school drinking glasses) or may only pay for a percentage or fixed amount of selected items in the transaction (e.g., $50 of a tab for $100 of food purchased at a restaurant but not any of the $30 of the tab in drinks at the restaurant). When accepting and/or rejection payment for the transaction and/or individual items in the transaction, the second user may also enter one or more comments or replies, for example, a reply to a message sent by the first user in the transaction. The second user may also select to provide the first user with an account balance adjustment, one time account spending balance, and/or gift card having a set amount of funds available for use with the transaction.

The second user may utilize the payment provider to complete payment for the transaction, for example, through a payment account with the payment provider and/or with stored payment instruments with the payment provider (e.g., credit/debit/gift card, checking account, etc.). The second user may also utilize a merchant application/website to complete payment or may send payment information directly to the merchant. The second user may also set rules for payment of the transaction or at least one item in the transaction. For example, where the second user has chosen to not pay for certain items in the transaction, the second user may request that the merchant void those items and refuse sale for those items if the first user still wishes the second user to pay for accepted items. Such rules and/or conditions may also affect future transactions and/or account balances provided to the first user. Additionally, such rules/conditions may apply to the purchased items, such as only using a purchased item for a particular purpose. Where the second user refuses purchase of the entire transaction, the second user may also be given the option to alert/notify the merchant, for example, to request that the merchant not provide sales to the first user.

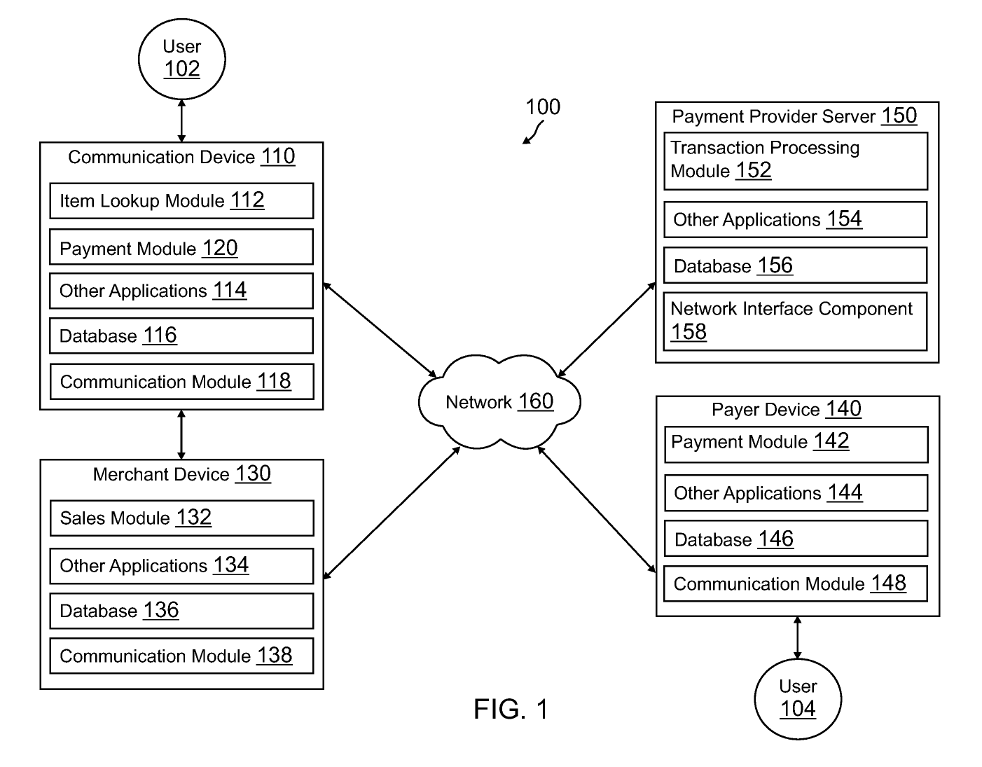

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user 104, a communication device 110, a merchant device 130, a payer device 140, and payment provider server 150 in communication over a network 160. User 102, such as a consumer or the first user, may utilize communication device 110 to generate a transaction with a merchant corresponding to merchant device 130. Communication device 110 and/or merchant device 130 may communicate the transaction to payer device 140 for approval and payment. User 104, such as the second user, may then utilize payer device 140 to pay for all or part of the transaction, and communicate user 104's decision to at least communication device 110.

Communication device 110, merchant device 130, payer device 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Communication device 110 may be implemented using any appropriate hardware and software configured for wired and/or wireless communication with merchant device 130, payer device 140, and/or payment provider server 150. For example, in one embodiment, communication device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly. Moreover, in various embodiments, one or more of the applications, processes, and/or features discussed below in reference to communication device 110 may be included in merchant device 130, and vice versa

Communication device 110 of FIG. 1 contains an item lookup module 112, a payment module 120, other applications 114, a database 116, and a communication module 118. Item lookup module 112, payment module 120, and other applications 114 may correspond to processes, procedures, and/or applications, for example, a software program, executable by a hardware processor. In other embodiments, communication device 110 may include additional or different modules having specialized hardware and/or software as required. Additionally, in certain embodiment where merchant device 130 generates, determines, and/or updates a transaction for user 102, one or more of the below described modules or functions of communication device 110 may be executed instead by merchant device 130 (e.g., item lookup module 112 and/or payment module 120).

Item lookup module 112 may correspond to one or more processes to execute modules and associated specialized hardware of communication device 110 to receiving a selection of one or more items for purchase, determine item information for the item(s) for purchase, and/or provide the item information to payment module 120. In this regard, item lookup module 112 may correspond to specialized hardware and/or software used to receive input correspond to at least one item user 102 has selected for purchase from a merchant corresponding to merchant device 130. Thus, item lookup module 112 may be used, for example, to provide a convenient interface to permit user 102 to select the item(s) for purchase or enter input correspond to the item(s). For example, in certain embodiments, item lookup module 112 may receive an image, scan, or other input for an item and/or code of the item (e.g., an alphanumeric, bar, and/or QR code). Item lookup module 112 may utilize such information to request item information, for example, from database 116 stored to a non-transitory memory of communication device 110, database 136 of merchant device 130, and/or another resource (e.g., online resources available over network 160).

In other embodiments, item lookup module 112 may correspond to a browser application or dedicated merchant application for the merchant associated with merchant device 130. Thus, item lookup module 112 may allow user 102 to browse the Internet, including navigation to websites and between webpages of websites. In such embodiments, item lookup module 112 may therefore be configured to transmit and receive information, such as webpage requests, input to webpages, downloads and uploads of data, such as data in database 116 of user device 110, etc. Thus, item lookup module 112 may be used to access a website corresponding to merchant device 130 and select one or more items and/or services for purchase in a transaction. In other embodiments, item lookup module 112 may correspond to a dedicated application for merchant device 130, such as a merchant specific application (e.g., a marketplace application specific to merchant device 130), where user 102 may view items/services available from merchant device 130 to purchase. Using item lookup module 112, user 102 may request the aforementioned item information. The item information may include at least a price of an item available with the merchant associated with merchant device 130. However, in certain embodiments, item information may further include a name of the item, a description of the item, a review of the item, contents of the item (including ingredients), services offered by or with the item, or further item information. Item information may be saved to a database, such as database 116, where the item information may be accessed by a module (e.g., payment module 120 and/or sales module 132) and used to generate a transaction for one or more selected items for purchase.

Payment module 120 may correspond to one or more processes to execute modules and associated specialized hardware of communication device 110 to select items for purchase, generate a transaction for the item(s) for purchase from item information for the item(s), communicate the transaction to payer device 140, and/or view notifications of user 104's approval or rejection. In this regard, item lookup module 112 may correspond to specialized hardware and/or software that user 102 may utilize to have user 104 (e.g., a payer) pay for the transaction. In generating a transaction, user 102 may enter a selection of items, such as through an input device of communication device 110. The selection of items may include one or more items for purchase from the merchant associated with merchant device 140. As previously discussed, an item may be entered and/or selected through an image or scan of the item/item code or through selection in a merchant application/website. Once the selection of item(s) is entered by user 102, payment module 120 may access item information for the item(s) and determine a transaction for the item(s). The transaction may include at least the price(s) for each of the item(s) as well as a transaction total. However, the transaction may further include additional item information, such as names, descriptions, etc.

Once user 102 is ready to complete the transaction, user 102 may have the transaction communicated to payer device 140 for payment. Communication device 110 may communicate the transaction directly to payer device 140, for example, over network 160. However, in other embodiments, communication device 110 may transmit the transaction to merchant device 130 for transmission to payer device 140, may have merchant device 130 transmit the transaction to payer device 140 (e.g., where merchant device 130 generates the transaction), or transmit the transaction to payment provider server 150 for communication to payer device 140. Thus, user 102 may enter information enabling identification of user 104, such as a name, account identifier, phone number, email address, messaging contact, or other identification information during checkout. User 102 may provide similar information for user 102's identification information enabling user 104 to identify who is requesting payment for the transaction. User 102 may also provide other information during checkout, such as a message or comment for the transaction, rules about payment for the transaction by user 104, and/or information about the transaction displayed to user 104 when requesting payment for the transaction.

Once user 104 has determined whether to accept or reject the transaction, user 102 may view the decision using payment module 120. If user 104 accepts payment, user 102 may view a notification of an acceptance of the transaction, a transaction history, comments/replies by user 104, payment, rules regarding user 104's payment of the transaction, rules regarding use of items/services in the transaction, and/or pickup information for completion of the transaction. If user 104 declines payment, user 102 may view the notification of the rejection of the transaction and any comments/replies made by user 104. In certain embodiments, user 104 may accept payment for certain items in the transaction and decline payment for other items in the transaction, as discussed herein. Thus, payment module 120 may display a notification detail which items user 104 has agreed to pay for as well as any comments/replies for the selected and/or unselected items for payment by user 104. Further, user 104 may choose to pay for a percentage or fixed amount for the transaction in general and/or one or more items in the transaction. Payment module 120 may display funding available to pay for part of the transaction and/or items in order to determine whether user 102 may utilize additional funding sources to complete the transaction. In certain embodiments, instead of providing payment or partial payment for the transaction and/or one or more items in the transaction, user 104 may provide funds in an account balance or through a payment/gift card. In such embodiments, payment module 120 may display available funding to user 102.

Additionally, based on the notification received regarding payment of the transaction, user 102 may utilize payment module 120 to complete payment for the transaction, or may request a new payer to be sent the transaction in order to pay for the transaction. Thus, payment module 120 may be used, for example, to provide a convenient interface to permit user 102 to select payment options for payment instruments and provide payment for items and/or services. Such payment instruments may include payments agreed to by user 104 (e.g., an acceptance to pay for all or part of a transaction/items) a payment account having funding made available by user 104, as well as gift cards, transaction approvals, and/or item approvals. For example, payment module 120 may be implemented as an application having a user interface enabling the user to enter payment options for storage by communication device 110, provide payment to merchant device 130, and complete a transaction for the items and/or services using the aforementioned payment instrument (e.g., a payment account with payment provider server 150). In certain embodiments, payment module 120 may correspond more generally to a web browser configured to view information available over the Internet or access a website corresponding to a payment provider. Thus, after acceptance of all or part of the transaction/items available in the transaction, user 102 may complete payment for the transaction using payment module 120. However, in other embodiments, user 104 may provide payment directly to merchant device 130 or to merchant device 130 using a payment module and/or payment provider server 150, where user 102 is notified of the payment through payment module 120.

In various embodiments, one or more features of item lookup module 112 and/or payment module 120 may be incorporated in the same module so as to provide their respective features in one module.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160, for example, to user 104. In various embodiments, other applications 114 may include financial applications, such as banking, online payments, money transfer, or other applications associated with payment provider server 150. Other applications 114 may include browser, social networking, and/or mapping applications where not provided in one or more of item lookup module 112 and/or payment module 120. Various applications, features, and/or processes of other applications 114 may be used in conjunction with item lookup module 112 and/or payment module 120. Other applications 114 may contain software programs, executable by a processor, including a graphical user interface (GUI) configured to provide an interface to the user.

Communication device 110 may further include database 116 which may include, for example, identifiers such as operating system registry entries, cookies associated with item lookup module 112, payment module 120, and/or other applications 114, identifiers associated with hardware of communication device 110, or other appropriate identifiers, such as identifiers used for payment/user/device authentication or identification. Identifiers in database 116 may be used by a payment/credit provider, such as payment provider server 150, to associate communication device 110 with a particular account maintained by the payment/credit provider. The identifiers may also be used by a merchant, such as merchant device 130 to identify user 102 and/or a merchant account with the merchant. Database 116 may include a transaction, transaction information (e.g., comments/replies associated with a transaction), and/or payment decisions for transaction after receipt from one or more of merchant device 130 and/or payment provider server 150. Database 116 may also include item information for use in generating a transaction.

Communication device 110 includes at least one communication module 118 adapted to communicate with merchant device 130, payer device 140, and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 130 may be maintained, for example, by an online merchant, which may offer one or more items and/or services for purchase through a merchant location and/or merchant application. In this regard, merchant device 130 includes one or more processing applications which may be configured to interact with communication device 110 and/or payer device 140 to facilitate generation of a transaction and payment for the transaction using a payment token. In various embodiments, merchant device 130 may instead correspond to a server offering one or more items for purchase. For example, merchant device 130 may be provided by EBAY®, Inc. of San Jose, Calif., USA or STUBHUB®, Inc. of San Francisco, Calif. However, in other embodiments, merchant device 130 may be maintained by or include any merchant, including merchants that offer offline sales of items and/or services through merchant locations. In such embodiments, merchant device may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Moreover, in various embodiments, one or more of the applications, processes, and/or features discussed below in reference to merchant device 130 may be included in communication device 110, and vice versa.

Merchant device 130 of FIG. 1 contains a sales module 132, other applications 134, a database 136, and a communication module 138. Sales module 132 and other applications 134 may correspond to processes, procedures, and/or applications, for example, a software program, executable by a hardware processor. In other embodiments, merchant device 130 may include additional or different modules having specialized hardware and/or software as required. Additionally, in certain embodiment where merchant device 130 generates, determines, and/or updates a transaction for user 102, one or more of the above described modules or functions of communication device 110 may be executed instead by merchant device 130 (e.g., item lookup module 112 and/or payment module 120).

Sales module 132 may correspond to one or more processes to execute modules and associated specialized hardware of communication device 110 to provide a merchant sales and/or marketplace application interface permitting user 102 to browse items for sale from a merchant corresponding to merchant device 130. In this regard, sales module 132 may correspond to specialized hardware and/or software to access and/or provide item information for use in generating a transaction with the merchant associated with merchant device 130. For example, in certain embodiments, sales module 132 may transmit the application interface over network 160 to user device 110 for display to user 102, for example, using item lookup module 112. The interface may enable user 102 to view one or more items and/or services for sale from the merchant and select one or more of the items/services for purchase. After selecting items for purchase, payment module 120 and/or sales module 132 may generate a transaction for the selected item(s), as discussed herein, for example, by gathering the item(s)/service(s) into a shopping basket and providing a checkout interface for completion of the transaction. The checkout interface may include an option for user 102 to provide payment for the transaction, for example, using payment module 120 and payment provider server 150. In various embodiments, the checkout interface may further allow user 102 to enter information to have another user (e.g., a payer, such as user 104) to provide payment for the transaction.

If payment by another user is selected by user 102, sales module 132 may suspend the transaction for user 102 where sales module 132 has generated the transaction. However, where payment module 120 generates the transaction and provides the transaction to user 104 through payer device 140 for payment, sales module 132 may instead receive the transaction from one or more of communication device 110, payer device 140, and/or payment provider server 150, as well as any payments for the transaction and/or comments/replies/instructions regarding the transaction. For example, where user 104 agrees to payment or partial payment for the transaction or at least one item in the transaction, sales module 132 may receive the transaction as well as the payment or partial payment. In other embodiments where user 104 provides payment credit and/or account balances to user 102 through payment module 120, sales module 132 may be utilized to process and complete the transaction. Sales module 132 may also receive direct payment from user 104, such as through a payment transmitted to merchant device 130 over network 160 or from input by a merchant employee while utilizing merchant device 130.

Additionally, sales module 132 may display comments, replies, and/or instructions regarding a transaction to a merchant employee at a merchant location for use with user 102 and the transaction. Thus, if user 104 wishes to prevent user 102 from making an unauthorized purchase, the merchant employee at the merchant location may be notified of the instructions regarding the transaction. Sales module 132 may also be utilized to provide user 104 with information regarding user 102 while at the merchant location, the transaction, one or more items in the transaction, and/or the merchant. Thus, sales module 132 may include messaging, phone, email, and/or online communication processes that may provide information and/or answer questions for user 104.

In certain embodiments where the transaction may be generated with communication device 110 and/or sales module 132 for communication to payer device 140, the transaction may be entered based on selected items in a physical possession of user 102, such as held by user 102 and/or in a shopping basket/cart of user 102. Thus, user 102 may utilize communication device 110 and/or merchant device 130 to scan the item(s) into a transaction, as discussed herein. Each item may include a device configured to receive the decision to accept or reject purchase of each item. Thus, after communication of the transaction to payer device 140 and receipt of a notification having an acceptance or rejection of one or more items in the transaction, the device include on, attached to, or associated with each item may alert user 102 of whether payment for the item was accepted by user 104. For example, the item's device may light up green if user 104 has accepted to purchase the item for user 102. However, if user 104 rejects purchase of the item, the item's device may light up red. Other visual, audio, and/or audiovisual signifier/alerts may be utilized. The item's device may receive data used to alert user 102 of whether the item was purchased from one or more of communication device 110, merchant device 130, payer device 140, and/or payment provider server 150.

In various embodiments, merchant device 130 includes other applications 134 as may be desired in particular embodiments to provide features to merchant device 130. For example, other applications 134 may include security applications for implementing client-side security features, programmatic client applications for interfacing with appropriate application programming interfaces (APIs) over network 160, or other types of applications. Other applications 134 may contain software programs, executable by a processor, including a graphical user interface (GUI), configured to provide an interface to a user. In various embodiments where not provided by sales module 132, merchant device 130 may include communication applications, such as messaging, phone, email, or other applications for use in contacting user 104.

Additionally, merchant device 130 includes database 136. User 102 and/or user 104 may establish one or more merchant accounts having user information with merchant device 130. User accounts in database 136 may include a name, address, birthdate, payment/funding information, additional user financial information, and/or other desired user data. User 102 and/or user 104 may link to their respective accounts through a user and/or device identifier. In other embodiments, user 102 and/or user 104 may not have previously established an account and may provide other information to merchant device 130 to generate and/or complete financial transactions, as previously discussed. Database 136 may further include item information used by payment device 120 and/or sales module 132 to provide a merchant sales and/or marketplace interface, such as item information, pricing, merchant application interface components, and/or merchant information. Database 136 may further include transactions and/or payment information for such transactions.

In various embodiments, merchant device 130 includes at least one communication module 138 adapted to communicate communication device 110, payer device 140, and/or payment provider server 150 over network 160. In various embodiments, communication module 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payer device 140 may be implemented using any appropriate hardware and software configured for wired and/or wireless communication with communication device 110, merchant device 130, and/or payment provider server 150. Payer device 140 may correspond to a device utilized by user 104 to receive a transaction and choose to approve or decline payment for all or part of the transaction or one or more items in the transaction. Thus, payer device 140 may be implemented as a personal computer (PC), a smart phone, laptop computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a payer device is shown, the payer device may be managed or controlled by any suitable processing device. Although only one payer device is shown, a plurality of payer devices may function similarly.

Payer device 140 of FIG. 1 contains a payment module 142, other applications 144, a database 146, and a communication module 148. Payment module 142 and other applications 144 may correspond to processes, procedures, and/or applications, for example, a software program, executable by a hardware processor. In other embodiments, payer device 140 may include additional or different software as required.

Payment module 142 may correspond to one or more processes to execute modules and associated specialized hardware of communication device 110 to provide a convenient interface to permit user 104 to select payment options and provide payment for received transactions. In this regard, payment module 142 may correspond to specialized hardware and/or software to display a user interface enabling user 104 to enter payment options for storage by payer device 140, provide payment to merchant device 130 (e.g., directly, through a merchant application/website, and/or using payment provider server 150), and complete payment for a transaction. In certain embodiments, payment module 142 may correspond more generally to a web browser configured to view information available over the Internet or access a website corresponding to a payment provider. In other embodiments, payment module 142 may correspond to a dedicated merchant application for the merchant associated with merchant device 130 or a dedicated payment application, for example, associated with payment provider server 150.

Thus, payment module 142 may first receive a transaction, as discussed herein. In this regard, payment module 142 may correspond to an application that may provide an interface where user 102 may view the received transaction. The interface may display to user 104 the transaction information, including at least a payment amount for the transaction. The transaction information may further include a payment amount for each item in the transaction (e.g., a payment breakdown for the item(s) in the transaction), user 102's identification information, item information, merchant information, and/or comments entered by user 102 when generating the transaction and/or requesting payment for the transaction from user 104. Thus, the transaction may further include transaction details (e.g., items/services selected, cost of each selected item/service, tax costs, discounts or benefits applied to the transaction, merchant name for the transaction, etc.), identification information for user 102, a message, comment or note by user 102, a time until expiration of the transaction with merchant device 130, and/or merchant information.

If user 104 declines payment for the entire transaction, the decision to reject may be transmitted to payment provider server 150. However, user 104 may decide to accept payment for all or part of the transaction or one or more items in the transaction. User 104 may view the transaction and select an option to pay for all of the transaction in payment module 142 or may enter in a percentage or fixed amount to pay for the entire transaction. However, user 104 may also view each item in the transaction and choose to pay for all or part of individual items. User 104 may enter in a comment or reply for payment of the transaction and/or one or more items, which may be communicated to communication device 110 for viewing by user 102. In other embodiments, user 104 may enter instruction for the merchant or a merchant employee associated with merchant device 130. Such instruction may be communicated to merchant device 130 for use with the transaction. Payment module 142 may further provide an option for user 104 to contact the merchant associated with merchant device 130 for use in answering questions by user 104, providing item/transaction/merchant information, and/or completing direct payments to the merchant. Additionally, payment module 142 may allow user 104 to provide funds to a payment account, gift card, or other funding source for user 102 to utilize with the transaction. The funds provided by user 104 may include rules, instructions, or comments that prevent the funds from unauthorized use (e.g., for unauthorized items or with unauthorized merchants).

If user 104 accepts payment or partial payment for the transaction or one or more items in the transaction, a payment request may be communicated to payment provider server 150 by payment module 142. The payment request may instruct payment provider server 150 to provide the payment specified by user 104. Additionally, the payment request may denote a payment instrument that payment provider server 150 may utilize to provide the specified payment. Payment module 142 may utilize a credit/debit card, a bank account, payment account with payment provider server 150, etc., when either accepting or declining payment. In other embodiments, the payment request may be communicated directly to merchant device 130 for processing by merchant device 130.

The payment request may correspond to a token including the selected payment instrument for user 102 as well as identification of the specified payment and/or transaction in the payment token. Once the payment request is generated, user 104 may authorize the payment request for transmission to payment provider server 150 in order to effectuate a payment to merchant device 130 for the transaction. In other embodiments, payment module 142 may transmit the payment request as a token with a payment instrument, an identifier for user 104, and/or an identifier for the transaction to merchant device 130 for processing a payment for the transaction. Once a payment is processed for the transaction, payment module 142 may receive a transaction history documenting completion of the payment.

Payer device 140 includes other applications 144 as may be desired in particular embodiments to provide features to payer device 140. For example, other applications 144 may include security applications for implementing client-side security features, programmatic client applications for interfacing with appropriate application programming interfaces (APIs) over network 160, or other types of applications. Other applications 144 may also include email, texting, voice and IM applications that allow a user to send and receive emails, calls, texts, and other notifications through network 160, for example, to user 102. In various embodiments, other applications 144 may include financial applications, such as banking, online payments, money transfer, or other applications associated with payment provider server 150. Other applications 144 may include browser, social networking, and/or mapping applications. Various applications, features, and/or processes of other applications 144 may be used in conjunction with payment module 142. Other applications 144 may contain other software programs, executable by a processor, including a graphical user interface (GUI) configured to provide an interface to the user.

Payer device 140 may further include database 146 which may include, for example, identifiers such as operating system registry entries, cookies associated with payment module 142 and/or other applications 144, identifiers associated with hardware of payer device 140, or other appropriate identifiers, such as identifiers used for payment/user/device authentication or identification. In one embodiment, identifiers in database 146 may be used by merchant device 130 and/or payment provider server 150 to associate payer device 140 with a particular account maintained by merchant device 130 and/or payment provider server 150. Database 146 may also store received transactions and associated information, such as decisions on transactions and/or transaction histories for paid transaction and their associated payment tokens. Database 146 may also store financial information used by payment module 142 to process payments.

Payer device 140 includes at least one communication module 148 adapted to communicate with communication device 110, merchant device 130, and/or payment provider server 150. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 150 may be maintained, for example, by an online payment service provider, which may provide payment services and/or processing for financial transactions on behalf of users, including generation of tokens for use in requesting and completing payments by two or more users. In this regard, payment provider server 150 includes one or more processing applications which may be configured to interact with communication device 110, merchant device 130, and/or payer device 140 to facilitate payment for a transaction. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102 and/or the merchant. Moreover, in various embodiments, one or more of the applications, processes, and/or features discussed below in reference to payment provider server 150 may be included in merchant device 130, and vice versa.

Payment provider server 150 of FIG. 1 includes a transaction processing application 152, other applications 154, a database 156, and a network interface component 158. Transaction processing application 152 and other applications 154 may correspond to processes, procedures, and/or applications, for example, a software program, executable by a hardware processor. In other embodiments, payment provider server 150 may include additional or different modules having specialized hardware and/or software as required.

Transaction processing module 152 may correspond to one or more processes to execute modules and associated specialized hardware of payment provider server 150 to receive and/or transmit information from communication device 110, merchant device 130, and/or payer device 140 for processing and completion of one or more transactions initiated by user 102. In this regard, transaction processing module 152 may correspond to specialized hardware and/or software to process a received transaction from communication device 110, merchant device 130, and/or payer device 140 by receiving the transaction from communication device 110, merchant device 130, and/or payer device 140 with a payment request for a payment or partial payment for the transaction or one or more items in the transaction. The payment request may be encrypted prior to transmission to transaction processing module 152 to prevent unauthorized receipt of a payment instrument. The payment request may include information corresponding to user identifiers, user financial information/identifiers, transaction information and/or other identifiers. Additionally, the payment request may include a payment amount and terms of payment for the transaction. Once received, transaction processing module 152 may utilize a payment account or financial information (e.g., a payment instrument such as a credit/debit card, bank account, etc.) of user 104 to render payment for the transaction. Payment may be made to merchant device 130 using the payment instrument and the terms of the payment request. Additionally, transaction processing module 152 may provide transaction histories, including receipts, to communication device 110 and/or entity server for completion and documentation of the financial transaction.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 160, or other types of applications. Other applications 154 may contain software programs, executable by a processor, including a graphical user interface (GUI), configured to provide an interface to a user.

Additionally, payment provider server 150 includes database 156. As previously discussed, user 102, user 104, and/or the merchant corresponding to merchant device 130 may establish one or more payment accounts with payment provider server 150. User accounts in database 156 may include user/merchant information, such as name, address, birthdate, payment/funding information, additional user financial information, and/or other desired user data. User 102, user 104, and/or the merchant may link to their respective payment accounts through a user, merchant, and/or device identifier. Thus, when an identifier is transmitted to payment provider server 150, e.g. from communication device 110, merchant device 130, and/or payer device 140, a payment account belonging to user 102, user 104, and/or the merchant may be found. In other embodiments, user 102, user 104, and/or the merchant may not have previously established a payment account and may provide other financial information to payment provider server 150 to complete financial transactions, as previously discussed.

In various embodiments, payment provider server 150 includes at least one network interface component 158 adapted to communicate communication device 110, merchant device 130, and/or payer device 140 over network 160. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

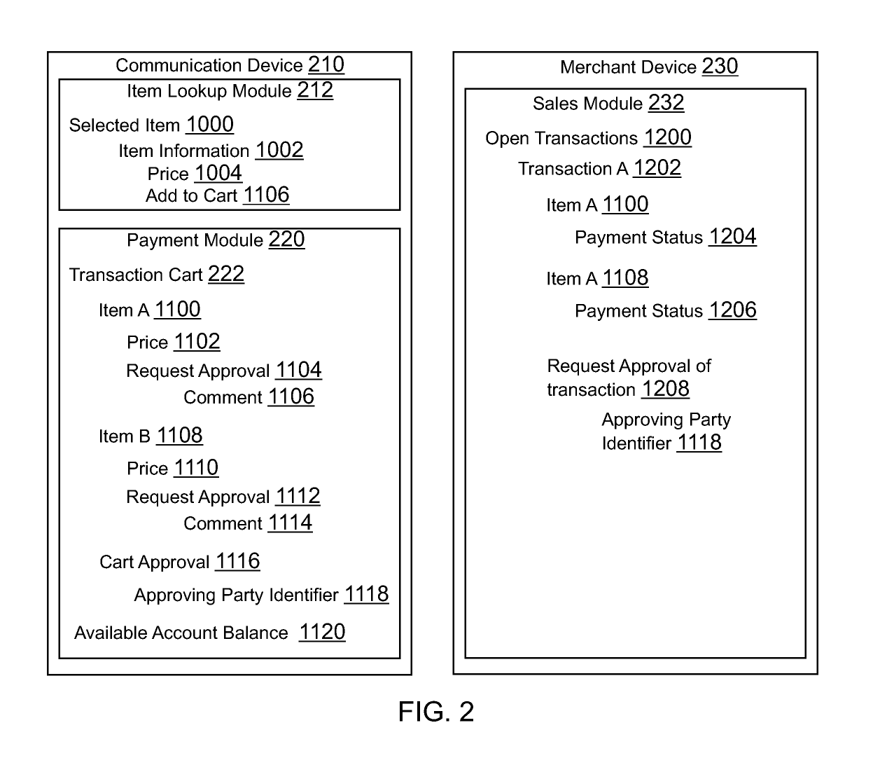

FIG. 2 is an exemplary system environment showing a communication device generating a transaction with a merchant device for approval from a payer, according to an embodiment. Environment 200 includes a communication device 210 and a merchant device 230 corresponding generally to communication device 110 and merchant device 130, respectively, of FIG. 1.

In environment 200, communication device 210 executes an item lookup module 212 and a payment module 220 corresponding generally to the specialized hardware and/or software modules and processes described in reference to item lookup module 212 and payment module 120, respectively, of FIG. 1. In this regard, item lookup module 212 may be utilized by a user (not shown) of communication device 210 to select an item and retrieve item information for the item. As discussed herein, item lookup module 212 may correspond to a merchant application or browser application for accessing a merchant website. In other embodiments, item lookup module 212 may correspond to an application to enter an item image or scan and retrieve the item information. Thus, item lookup module includes a selected item 1000 having item information 1002 (e.g., a name, description, availability, contents, etc.), price 1004, and an “add to cart” 1006 option.

Payment module 220 may be utilized to provide payment for selected item 1000, as well as other selected items, for example, through a transaction generated using the item(s). In this regard, payment module 220 includes a transaction cart 222 and an available account balance 1120. Transaction cart 222 includes items for purchase, such as an item A 1100 and an item B 1108. While in transaction cart 222, item A 1100 may include item information, such as a price 1102. Similarly, item B 1108 include a price 1110. Item A 1100 further includes an option to request approval 1104 for just item A 1100, as well as add a comment 1106 for item A 1100. In similar fashion, item B includes an option to request approval 1112 and a comment 1114. The user may also request approval of transaction cart 222 by selection cart approval 1116. The user may select the paying party through approving part identifier 1118. In various embodiments, the user may also add a comment in a comment field (not shown) for all of transaction cart 222. The user may provide payment for transaction cart 222 through available account balance 1120 where the user has available funds or a payer provides the user with available funds.

Merchant device 230 executes a sales module 232 corresponding generally to the specialized hardware and/or software modules and processes described in reference to sales module 132 of FIG. 1. Merchant device 230 may provide item information to communication device 210 for use in generating a transaction. In certain embodiments, merchant device 230 may generate the transaction or may open the transaction for the user of communication device 210 for payment by a payer. In this regard, sales module 232 includes open transactions 1200, such as a transaction A 1202 corresponding to transaction cart 222. Thus, transaction A 1202 includes item A 1100 and item B 1108. Item A 1100 may have a payment status 1204 while waiting for and/or receiving a payment decision from the payer. Similarly, item B 1108 has a payment status 1206. Transaction A 1202 may also include an option for a merchant/merchant employee to request payment from a payer, such as through an option to request approval of transaction 1208 and using an approving party identifier 1118.

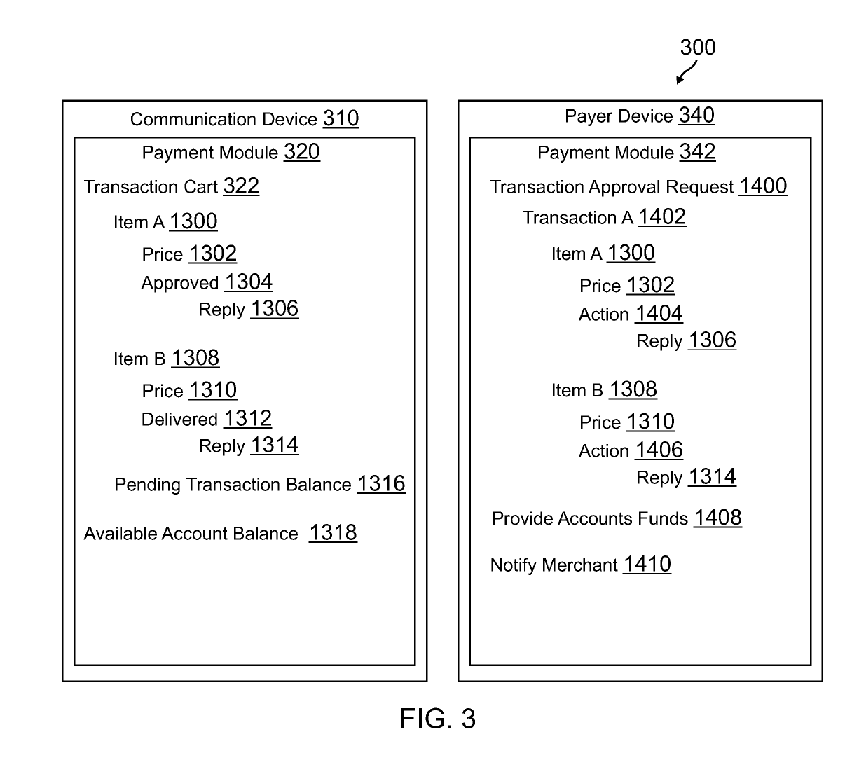

FIG. 3 is an exemplary system environment showing a payer device receiving an approval and/or rejection for payment of transaction and communicating the approval and/or rejection to the user's communication device, according to an embodiment. Environment 300 includes a communication device 310 and a payer device 340 corresponding generally to communication device 110 and payer device 140, respectively, of FIG. 1.

Payer device 340 executes a payment module 342 corresponding generally to the specialized hardware and/or software modules and processes described in reference to payment module 142 of FIG. 1. Payment module 342 may correspond to an interface displayable after receiving a request to pay for a transaction, for example, from communication device 210 and/or merchant device 230 of FIG. 2. In this regard, payment module 342 includes a transaction approval request 1400, an option to provide account funds 1408, and an option to notify merchant 1410. Transaction approval request 1400 includes transaction A 1402 corresponding generally to transaction cart 222 and/or transaction A 1202 of FIG. 2. Thus, transaction A 1402 includes an item A 1300 and an item B 1308. Item A 1300 displays item information necessary for the payer (not shown) associated with payer device 340 to make decisions regarding approval or rejection of at least item A 1300. Thus, item A 1300 includes a price 1302. Additionally, item A 1300 includes an action 1404, such as an option to approve or decline payment for item A 1300, such as payment for price 1302. The payer may further ad a reply 1306, such as an explanation for payment or refusal of payment, a reply to a comment by the user, and/or instructions to the merchant offering item A 1300 for sale. Similarly, item B 1308 includes a price 1310, an action 1406, and a reply 1314. In various embodiments, the payer may select and/or choose to pay for individual items and/or a portion of each individual item. In certain embodiments, the payer may also be given an option (not shown) to pay overall for transaction A 1402 and/or a portion of the transaction. Additionally, the payer may be given the option to provide account fund 1408, such as a monetary transfer into a payment account that the user requesting approval of transaction A 1402 may utilize. Where the payer has questions about transaction A 1402, wishes to notify the merchant about transaction A 1400, or would like to directly pay with the merchant, the payer may select an option to notify merchant 1410.

Communication device 310 executes a payment module 320 corresponding generally to the specialized hardware and/or software modules and processes described in reference to payment module 320 of FIG. 1. Payment module 320 displays an interface where the user (not shown) of communication device 310 may view decisions and/or notifications related to payment of a transaction, such as a transaction in transaction cart 322 (e.g., transaction A 1402). In this regard, transaction cart 322 includes an item A 1300 with a price 1302 and an item B 1300 with a price 1310, as also shown under transaction A 1402. While in transaction cart 322, information presented under item A 1300 may also include an approved 1304 status, such as a status of a payment from action 1404. Item A 1300 may also be included with reply 1306 from payer device 340. In contrast, item B 1308 is shown with a declined 1312 status corresponding to action 1406 with a reply 1314. Thus, the payer may have chosen to pay for item A 1300 but not item B 1308. Thus, transaction cart 322 may include a pending transaction balance 1316, which may include a total for item B 1308 if the user wishes to still purchase item B 1308. In order to complete a payment for item B 1308, the user may utilize an available account balance 1318, such as funds in a payment/gift card for the user.

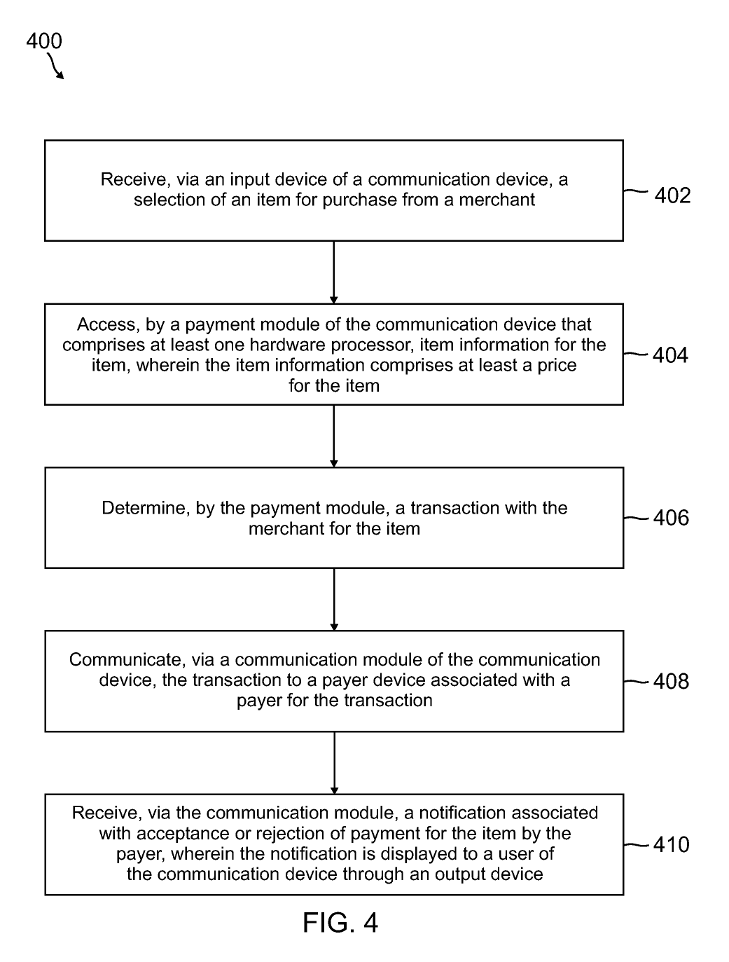

FIG. 4 is a flowchart of an exemplary process for communication device interfaces for transaction approval at a merchant location, according to an embodiment. Note that one or more steps, processes, and methods described herein may be omitted, performed in a different sequence, or combined as desired or appropriate.

At step 402, a selection of an item for purchase from a merchant is received, for example, via an input device of a communication device. The input device may comprise at least one of an interface of the communication device having a displayable listing of items available with the merchant, an optical recording device, and a scanner device, wherein the selection of the item comprises at least one of a selection of the item from the displayable listing, an image of the item, and a scan of a code associated with the item. Thus, an item lookup module may receive the selection of the item and determine item information for the item, wherein the item information comprises at least price for each of the item. The item information may include further item information, such as item name, description, availability, contents, associated services, delivery/pickup information, redemption information, or other information. The item lookup module may determine the item information by requesting the item information from one of a merchant device associated with the merchant and a service provider associated with the merchant using a communication module.

Item information for the item is accessed, by a payment module of the communication device that comprises at least one hardware processor, wherein the item information comprises at least a price for the item, at step 404. A transaction with the merchant for the item is determined by the payment module, at step 406. The transaction may be a sale of the item to a user of the communication device, such as a requester for the transaction. However, the user may not have sufficient available funds to pay for the transaction. Thus, at step 408, the transaction is communicated to a payer device associated with a payer for the transaction via a communication module.

At step 410, a notification associated with acceptance or rejection of payment for the transaction/item by the payer is received, via the communication module, wherein the notification is displayed to a user of the communication device through an output device. Thus, the notification may comprise one of an approval of payment for at least one item in the transaction by a payer associated with the payer device and a rejection of payment for the at least one item by the payer. The notification may further comprise a message from the payer and associated with one of the approval for payment by the payer and the rejection of payment by the payer.

The merchant may receive the notification and process the transaction in accordance with the notification, for example, by processing a payment with the payer for the transaction/item, providing the transaction item(s) to the user, and/or canceling the transaction. In order to complete a payment for the item/transaction when the payer provides an approval for at least one item in the transaction, a payment provider may receive the approval of the payment from one of a merchant device associated with the merchant, the payer device, and the communication device, wherein the payment provider may process the approval to provide a monetary amount to the merchant for the at least one item or the transaction. The payment provider may utilize a payment account of the payer to provide the monetary amount to the merchant.

In various embodiments, the notification may comprise a partial approval of payment for the at least one item, wherein the partial approval comprises one of a payment for less than all items in the transaction and a partial payment for one of the transaction and the at least one item. The notification may also comprise an indication of selected items in the at least one item for payment by a payer associated with the payer device. Thus, a merchant device associated with the merchant may receive the notification and update the transaction to comprise the selected items by the payer. The merchant may refuse sale of items in the transaction not included in the selected item, for example, based on a comment, reply, or instruction by the payer in the approval of only the selected items. In certain embodiments, when viewing a transaction the payer may update a payment account for use with the transaction. Thus, the notification may comprise an update to an account balance of a payment account for a user associated with the communication device. Using the account balance, the payment module may further process a payment to the merchant for the transaction using at least the payment account.

The transaction may be communicated to the payer device with a merchant identifier for the merchant, wherein the payer utilizes the merchant identifier to request additional information associated with the transaction from the merchant. For example, the additional information may comprise at least one of the item information, a question related to the item in the transaction, a question related to the transaction, and a request for direct payment to the merchant by the payer. Additionally, when communicating the transaction to the payer device, the communication device may request the transaction is communicated to the payer device from a merchant device associated with the merchant or transmit the transaction to a payment service provider for communication to the payer device. Thus, the communication device may provide at least one of a name for the payer, an email address for the payer, a phone number for the payer, an account of the payer, and a messaging identifier for the payer with the transaction for use when communicating the transaction to the payer device.

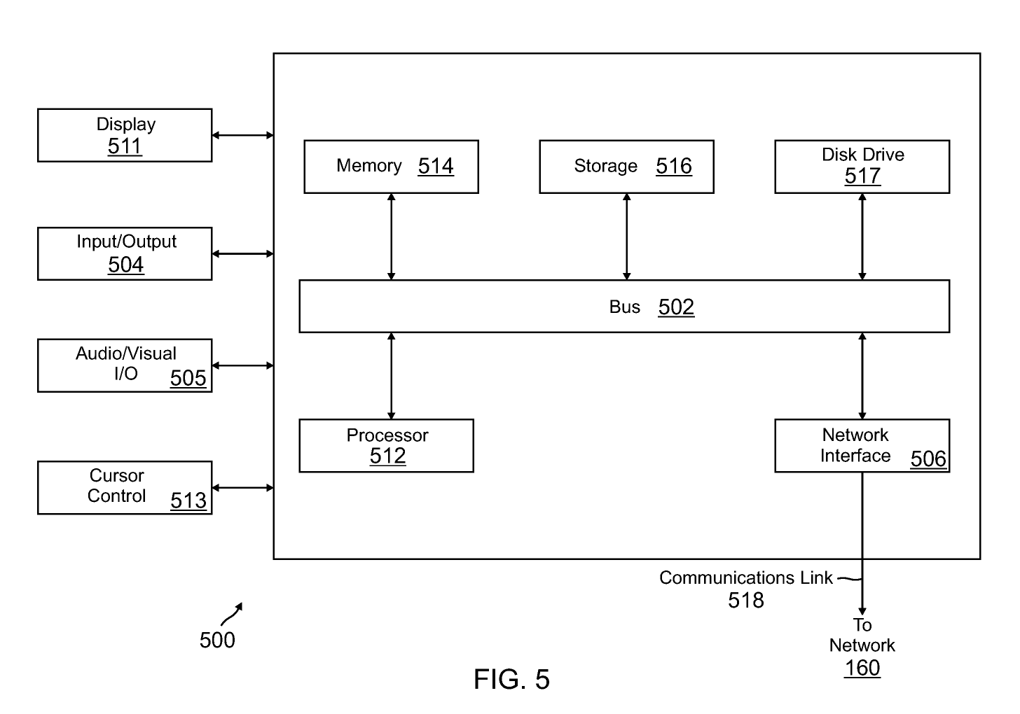

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an input device for receiving a selection of at least one item available with a merchant;
an output device for displaying a notification associated with a request for approval for a transaction from a payer device, wherein the transaction comprises the at least one item available with the merchant;
an input/output (i/o) interface in communication with the input device and the output device;
a non-transitory memory storing item information for the at least one item, the transaction comprising the at least one item available with the merchant, the request for approval for the transaction from a payer device, and the notification associated with the request for approval of the transaction;
a payment module comprising at least one hardware processor that access the item information for the at least one item available with the merchant, determines the transaction using the item information, generates the request for approval for the transaction from the payer device, and outputs the notification associated with the request using the output device; and
a communication module of the communication device that receives the item information for the at least one item, communicates the request for approval for the transaction from the payer device, and receives the notification associated with the request.

2. The system of claim 1, wherein the notification comprises one of an approval of payment for the at least one item by a payer associated with the payer device and a rejection of payment for the at least one item by the payer.

3. The system of claim 2, wherein the notification further comprises a message from the payer and associated with one of the approval for payment by the payer and the rejection of payment by the payer.

4. The system of claim 2, wherein the merchant receives the notification and processes the transaction in accordance with the notification.

5. The system of claim 2, wherein a payment provider receives the approval of the payment from one of a merchant device associated with the merchant, the payer device, and the communication device, and wherein the payment provider processes the approval to provide a monetary amount to the merchant for the at least one item.

6. The system of claim 5, wherein the payment provider utilizes a payment account of the payer to provide the monetary amount to the merchant.

7. The system of claim 1, wherein the notification comprises a partial approval of payment for the at least one item, wherein the partial approval comprises one of a payment for less than all items in the transaction and a partial payment for one of the transaction and the at least one item.

8. The system of claim 1, wherein the notification comprises an indication of selected items in the at least one item for payment by a payer associated with the payer device.

9. The system of claim 8, wherein a merchant device associated with the merchant receives the notification, and wherein the merchant updates the transaction to comprise the selected items by the payer.

10. The system of claim 8, wherein the merchant refuses sale of items in the transaction not included in the selected items.

11. The system of claim 1, wherein the notification comprises an update to an account balance of a payment account for a user associated with the communication device.

12. The system of claim 11, wherein the payment module further processes a payment to the merchant for the transaction using at least the payment account.

13. The system of claim 1, wherein the input device comprises at least one of an interface of the communication device having a displayable listing of items available with the merchant, an optical recording device, and a scanner device, wherein the selection of the at least one item comprises at least one of a selection of the at least one item from the displayable listing, an image of the at least one item, and a scan of a code associated with the at least one item:
an item lookup module that receives the selection of the at least one item and determines the item information for the at least one item, wherein the item information comprises a price for each of the at least one item.

14. The system of claim 13, wherein the item lookup module determines the item information by requesting the item information from one of a merchant device associated with the merchant and a service provider associated with the merchant using the communication module.

15. A method comprising:
receiving, via an input device of a communication device, a selection of an item for purchase from a merchant;
accessing, by a payment module of the communication device that comprises at least one hardware processor, item information for the item, wherein the item information comprises at least a price for the item;
determining, by the payment module, a transaction with the merchant for the item;
communicating, via a communication module of the communication device, the transaction to a payer device associated with a payer for the transaction with a message to the payer; and
receiving, via the communication module, a notification associated with acceptance or rejection of payment for one of the transaction and the item by the payer, wherein the notification is displayed to a user of the communication device through an output device.

16. The method of claim 15, wherein the transaction is communicated to the payer device with a merchant identifier for the merchant, and wherein the payer utilizes the merchant identifier to request additional information associated with the transaction from the merchant.

17. The method of claim 16, wherein the additional information comprises at least one of the item information, a question related to the item in the transaction, a question related to the transaction, and a request for direct payment to the merchant by the payer.

18. The system of claim 15, wherein the communicating the transaction to the payer device comprises one of requesting the transaction is communicated to the payer device from a merchant device associated with the merchant and transmitting the transaction to a payment service provider for communication to the payer device.

19. The system of claim 18, wherein the communication device provides at least one of a name for the payer, an email address for the payer, a phone number for the payer, an account of the payer, and a messaging identifier for the payer with the transaction for use when communicating the transaction to the payer device.

20. A non-transitory computer-readable medium comprising at least one module which, in response to execution by a computer system, cause the computer system to perform a method comprising:
receiving, via an input device of a merchant device, a selection of an item for purchase by a user from a merchant;
accessing, by a sales module of the merchant device that comprises at least one hardware processor, item information for the item, wherein the item information comprises at least a price for the item;
determining, by the sales module, a transaction between the user and the merchant for the item;
communicating, via a communication module of the communication device, the transaction to a payer device associated with a payer for the transaction;
receiving, via the communication module, a notification associated with acceptance or rejection of payment for one of the transaction and the item by the payer; and
processing, by the sales module, the transaction in accordance with the notification.
